(19) United States
(12) Patent Application Publication
(10) Pub. No.: US 2026/0017442 A1
(43) Pub. Date: Jan. 15, 2026

(54) INTEGRATED CIRCUIT LAYOUT AND METHOD OF GENERATING THEREOF

(71) Applicant: Taiwan Semiconductor Manufacturing Company, Ltd., Hsinchu (TW)

(72) Inventors: Chung-Hsing Wang, Chu-bei (TW); Meng-Kai Hsu, Xinfeng Township (TW); Chia-Chung Chen, Hsinchu (TW); Chung-Sheng Yuan, Hsinchu (TW); Yi-Kan Cheng, Hsinchu (TW)

(73) Assignee: Taiwan Semiconductor Manufacturing Company, Ltd., Hsinchu (TW)

(21) Appl. No.: 18/767,638

(22) Filed: Jul. 9, 2024

(51) Int. Cl. G06F 30/392; G06F 111/20; G06F 115/02; G06F 119/06

(52) U.S. Cl. CPC G06F 30/392; G06F 2111/20; G06F 2115/02; G06F 2119/06

(57) ABSTRACT

An integrated circuit layout includes a space that is arranged for the integrated circuit layout and includes a plurality of rows extending along a first direction, each of the plurality of rows having a uniform row height along a second direction perpendicular to the first direction. The integrated circuit layout also includes one or more first cell areas arranged in the space, one of the first cell areas being placed within one corresponding row of the plurality of rows; one or more second cell areas arranged in the space, one of the second cell areas being placed within two corresponding adjacent rows of the plurality of rows; and one or more third cell areas arranged in the space, one of the third cell areas being placed partially across three corresponding adjacent rows of the plurality of rows.

### BACKGROUND

Generally, electronic design automation (EDA) tools assist semiconductor designers to take a purely behavioral description of a desired circuit and work to fashion a finished layout of the circuit ready to be manufactured. This process usually takes the behavioral description of the circuit and turns it into a functional description, which is then decomposed into a number of Boolean functions and mapped into respective cell rows using a standard cell library. Once mapped, a synthesis is performed to turn the structural design into a physical layout, a clock tree is built to synchronize the structural elements, and the design is optimized post layout.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of a portion of an example integrated circuit layout in accordance with some embodiments.

FIG. 2 illustrates a schematic diagram of the portion of the integrated circuit of FIG. 1 at a certain metallization level in accordance with some embodiments.

FIG. 3 illustrates a schematic diagram of a first cell area of a plurality of cell areas included in the integrated circuit layout of FIG. 1 in accordance with some embodiments.

FIG. 4 illustrates a schematic diagram of a second cell area of a plurality of cell areas included in the integrated circuit layout of FIG. 1 in accordance with some embodiments.

FIG. 5 illustrates a schematic diagram of a third cell area of a plurality of cell areas included in the integrated circuit layout of FIG. 1 in accordance with some embodiments.

FIG. 6 illustrates an example layout of a plurality of cell areas included in the integrated circuit layout of FIG. 1 in accordance with an embodiments.

FIG. 7 illustrates another example layout of a plurality of cell areas included in the integrated circuit layout of FIG. 1 in accordance with another embodiments.

FIG. 8 illustrates a still another layout of a plurality of cell areas included in the integrated circuit layout of FIG. 1 in accordance with still another embodiments.

FIG. 9 illustrates a flow chart of an example method of generating an integrated circuit layout including a plurality of cell areas in accordance with some embodiments.

FIG. 10 illustrates a schematic diagram of a portion of a netlist in accordance with some embodiments.

FIG. 11 illustrates a block diagram of an example information handling system (HIS) in accordance with some embodiments.

FIG. 12 is a chart illustrating different trends or requirements for different integrated circuit applications.

FIG. 13 illustrates a further layout of a plurality of cell areas included in an integrated circuit layout of FIG. 1 in accordance with still another embodiments.

FIG. 14 is a chart illustrating different trends or performances for different technical approaches.

FIG. 15 is a table that illustrates nano-sheet mixed threshold voltage (Vt) usage and recommendation.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In practice, some integrated circuits (ICs) are more performance-orientated, while other integrated circuits are more power/area-orientated, for example. As such, to design an integrated circuit that consumes low power and occupies a small area without sacrificing its performance (e.g., a balance-orientated circuit), various design compromises are typically made. In designing integrated circuits, a larger active region (OD) width may bring higher speed, energy consumption, and leakage, while a smaller OD width may bring lower speed, energy consumption, and leakage, and tuning an OD width is more efficient than tuning gate (PO) numbers to achieve a balanced or acceptable speed, energy consumption, and leakage.

The present disclosure provides various embodiments of integrated circuit layouts. In accordance with some embodiments, an integrated circuit layout includes a space that is arranged for the integrated circuit layout and includes a plurality of rows extending along a first direction. Each of the plurality of rows has a uniform row height along a second direction perpendicular to the first direction, and is defined by a first power line (e.g., Vdd) and a second power line (e.g., Vss) both extending along the first direction and adjacent to each other along the second direction. The integrated circuit layout also includes one or more first cell areas arranged in the space, one of the first cell areas being placed within one corresponding row of the plurality of rows; one or more second cell areas arranged in the space, one of the second cell areas being placed within two corresponding adjacent rows of the plurality of rows; and one or more third cell areas arranged in the space, one of the third cell areas being placed partially across three corresponding adjacent rows of the plurality of rows. As such, the cell areas of the integrated circuit layout may have a configuration of merged channels or merged ODs.

In accordance with some embodiments, the first cell area includes: a first sub-area including a first channel of a first doping type extending across the first cell area along the first direction, the first channel having a first channel width along the second direction; and a second sub-area directly abutting the first sub-area along the second direction, and including a second channel of a second doping type opposite to the first doping type extending across the first cell area along the first direction, the second channel having a second channel width equal to the first channel width along the second direction.

In accordance with some embodiments, the second cell area includes: a third sub-area including a third channel of the first doping type, the third channel extending across the second cell area along the first direction and having a third channel width along the second direction; a fourth sub-area including a fourth channel of the first doping type, the fourth channel extending across the second cell area along the first direction and having a fourth channel width equal to the third channel width along the second direction; and a fifth sub-area placed between the third sub-area and the fourth sub-area along the second direction, and including a fifth channel of the second doping type, the fifth channel extending across the second cell area along the first direction and having a fifth channel width greater than any of the third channel width and the fourth channel width along the second direction. The fifth channel width of the second cell area is greater than the first channel of the first cell area width along the second direction.

In accordance with some embodiments, the third cell area includes: a six sub-area including a sixth channel of the first doping type, extending across the third cell area along the first direction, and having a sixth channel width along the second direction; and a seventh sub-area including a seventh channel of the second doping type, also extending across the third cell area along the first direction, and having a seventh channel width equal to the sixth channel width along the second direction. The sixth channel width of the third cell area is greater than the first channel width of the first cell area along the second direction. In some embodiments, the third cell area is placed entirely across a first corresponding row of the three corresponding adjacent rows and partially across a second and a third corresponding rows of the three corresponding adjacent rows on opposite sides of the first corresponding row along the second direction.

Various advantages may be presented by the integrated circuit layout adopting the configuration of merged ODs. The configuration of merged ODs may bring optimized and/or balanced power, performance, and area considerations throughout the design processes for various IC applications, for example, System-on-Chip (SoC), Graphics Processing Unit (GPU), embedded CPU (e-CPU), physical CPU (pCPU), and High-Performance Computing (HPC), thereby leading to overall improved performance, power efficiency, and area efficiency.

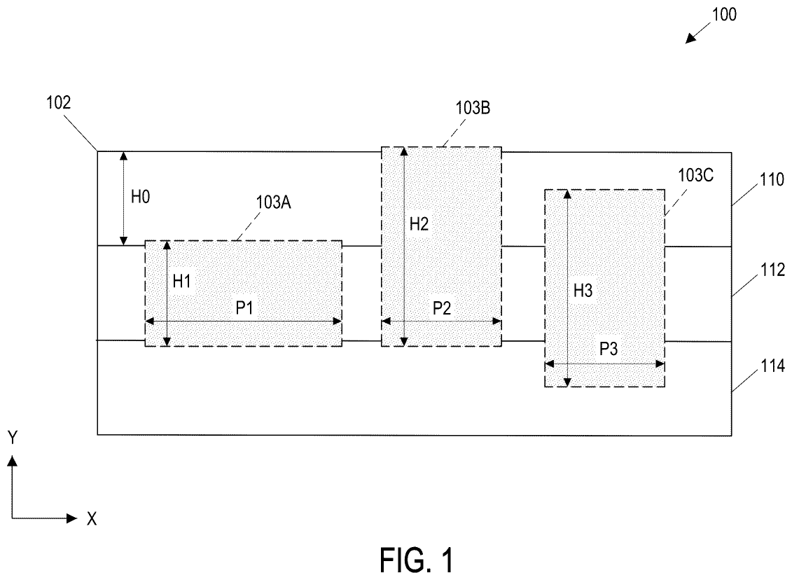

FIG. 1 illustrates a schematic diagram of a portion of an example integrated circuit or integrated circuit layout 100 designed by systems and methods of the present disclosure in accordance with some embodiments. Not all of the illustrated components are required, however, and some embodiments of the present disclosure may include additional components not shown in FIG. 1. Variations in the arrangement and type of the components may be made without departing from the scope of the present disclosure as set forth herein. Additional, different, or fewer components may be included.

Referring to FIG. 1, the integrated circuit layout 100 includes a plurality of uniform cell rows 110, 112 and 114 etc. arranged (e.g., laid out) across along a first direction (the X direction) and with respect to a space, grid, or floorplan 102 that is arranged for a design of the integrate circuit layout 100. In some embodiments, each of the uniform cell rows 110-114 of the integrated circuit layout 100 may present a uniform (or identical) row height H0 along a second direction (the Y direction) perpendicular to the first direction. In some embodiments, a uniform row height H0 is in a range from 100 nm to 140 nm, and in other embodiments, the uniform row height H0 is in anther range from 140 nm to 190 nm.

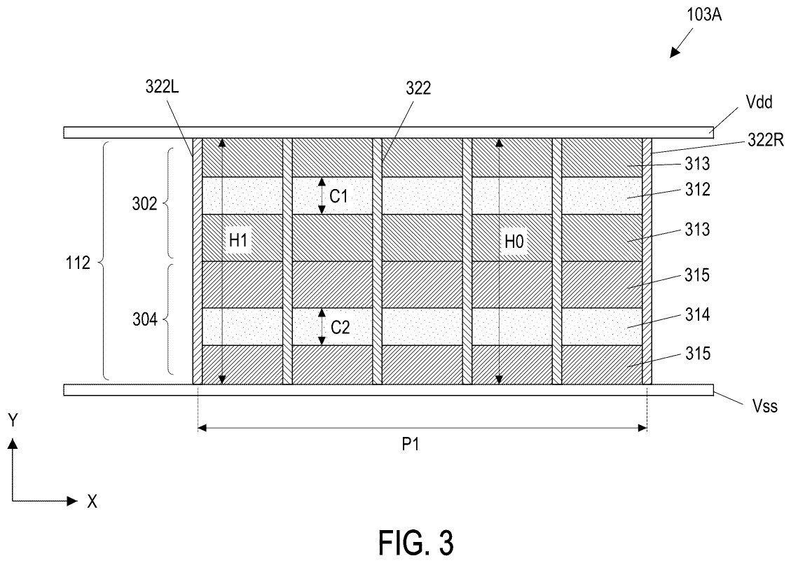

As shown in FIG. 1, the integrated circuit layout 100 can include a plurality of contiguous cell areas or cell areas, such as 103A, 103B and 103C, and each of the plurality of cell areas consists of one or more uniform cell rows extending within or across the space 102 along the first direction. For example, the contiguous cell area 103A consists of (or expanded by) one cell row 112, which extends within or across the space 102 along the first direction. The contiguous cell area 103B consists of (or expanded by) two cell rows 110 and 112, both of which extend within or across the space 102 along the first direction. The contiguous cell area 103C consists of (or expanded by) three corresponding adjacent rows of the plurality of rows, for example, an entire row 112, a portion of row 110, and a portion of row 114, all of which extend within or across the space 102 along the first direction. The contiguous cell area 103A has a first cell area pitch P1 along the first direction, and a first cell area heigh H1 along the second direction, H1=H0. The contiguous cell area 103B has a second cell area pitch P2 along the first direction, and a second cell area heigh H2 along the second direction, H2=2×H0. The contiguous cell area 103C has a third cell area pitch P3 along the first direction, and a third cell area heigh H3 along the second direction, H3 is in a range such as H0<H3<3×H0. In some embodiments, H3 is in a range such as H0<H3<2×H0, while in other embodiments, H3 is in another range such as 2×H0<H3<3×H0. Details about the configurations and arrangements of the contiguous cell areas will be explained later with respect to FIGS. 3, 4 and 5.

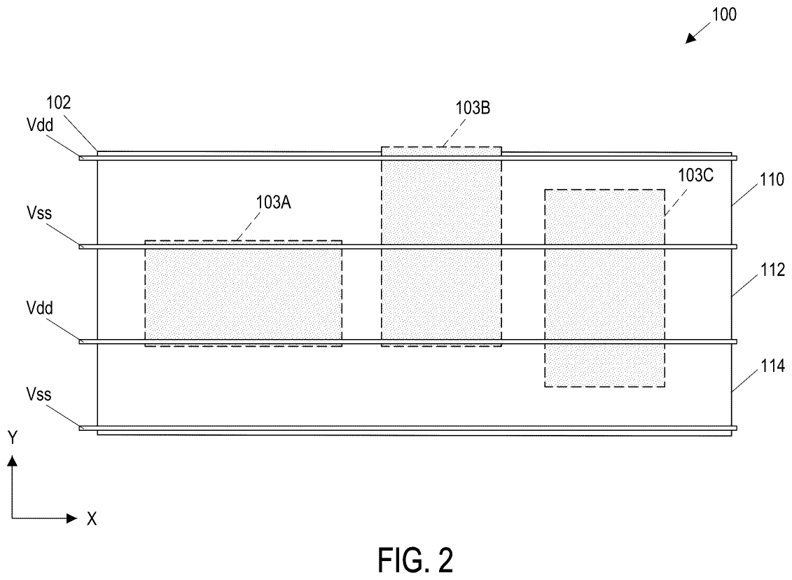

FIG. 2 illustrates a schematic diagram of a portion of the integrated circuit 100 of FIG. 1 at a certain metallization level (e.g., M1 level) in accordance with some embodiments. In some embodiments, each of the uniform cell rows, along a second direction (the Y direction) perpendicular to the first direction (the X direction), is bounded at its respective sides with a first metal rail and a second metal rail. The first metal rail can be a Vdd power rail that is configured to provide Vdd to each of the cells that are placed within the cell row, and the second metal rail can be a Vss power rail that is configured to provide Vss to each of the cells that are placed within the cell row.

As shown in FIG. 2, the cell rows, adjacent to each other along the second direction, may combine, abut, or otherwise share the same Vdd power rail or Vss power rail. For example, cell row 110 may share the same Vss power rail with cell row 112. As the Vdd/Vss power rail may extend along the corresponding uniform cell row, it is appreciated that some of the Vdd/Vss power rails may completely extend across the space 102 along the X direction (e.g., the Vss power rail shared by cell rows 110 and 112) as shown in FIG. 2 in some embodiments, while the other Vdd/Vss power rails may partially extend across the space 102 along the X direction (not shown) in other embodiments. In some embodiments, one or more of the plurality of cell areas (such as 103A, 103B and 103C) in the space 102 of the integrated circuit 100 as shown in FIG. 2 are configured to create a nano-sheet transistors. Details about the nano-sheet transistors are omitted here.

In some embodiments, one or more contiguous cell areas, such as 103A, 103B and 103C, in the space 102 of the integrated circuit 100 as shown in FIG. 2 correspond one or more circuit modules. The integrated circuit can arrange such contiguous cell areas based on identified circuit modules of the integrated circuit. For example, a circuit module may be identified or selected based on determining that the circuit module was previously specified (e.g., user-specified) as a performance-oriented circuit module. In another example, a circuit module may be identified based on determining that the circuit module was previously specified as a power-oriented circuit module.

The circuit module, as discussed herein, may refer to a set of circuit components that is configured to perform a certain function. For example, the integrated circuit can include a central processing unit (CPU), a graphic processing unit (GPU), an input/output (I/O) interface, and a memory. As such, a plurality of circuit modules, each of which can perform a certain function (e.g., calculation, reception of instruction, etc.), can collectively form the CPU. The integrated circuit or system can arrange such a contiguous cell area based on at least one of an identified timing constraint, an identified performance constraint, or an identified power constraint that can be shared by the cells disposed in the contiguous cell area. It is appreciated that such cells does not necessarily correspond to a same circuit module. In some embodiments, such a shared timing/performance/power constraint may be specified by the design or identified by performing one or more simulations on the circuit design of the integrated circuit using circuit simulators, for example, Simulation Program with Integrated Circuit Emphasis (SPICE).

FIG. 3 illustrates a schematic diagram of a first cell area (e.g., 103A) of a plurality of cell areas included in the integrated circuit layout 100 of FIG. 1 in accordance with some embodiments. As shown in FIG. 1, the first cell area 103A is arranged in a space 102 that includes a plurality of uniform cell rows (e.g., 110, 112 and 114). Each uniform cell row (e.g., 110) of the plurality of uniform cell rows extends along a first direction (X direction) in the space 102, and has a uniform row height H0 along a second direction (Y direction) perpendicular to the first direction. The first cell area 103A is placed within a corresponding uniform row (e.g., 112) of the plurality of uniform rows (e.g., 110, 112 and 114), and the first cell area 103A has a cell height H1 along the second direction and equal to the uniform row height H0. As shown in FIG. 3, top and bottom boundaries of the first cell area 103A are respectively defined in the second direction by a first power line and a second power line, both of which extending along the first direction and being adjacent to each other. In some embodiments, the first power line can be a Vdd power line, and the second power line can be a Vss power line.

As shown in FIG. 3, in some embodiments, a first cell area 103A includes a first sub-area 302 of PMOS type, and a second sub-area 304 of NMOS type abutting the first sub-area 302 along the second direction. The first sub-area 302 includes a first channel 312 of p-type that extends across the first cell area 103A along the first direction. The first channel 312 has a first channel width C1 along the second direction, and the first channel 312 is formed in a first well 313 of n-type. The second sub-area 304 includes a second channel 314 of n-type that extends across the first cell area 103A along the first direction. The second channel 314 has a second channel width C2 along the second direction, and the second channel 314 is formed in a second well 315 of p-type. In some embodiments, the second channel width C2 and the first channel height C1 are identical, while in other embodiments, the second channel width C2 and the first channel height C1 are different. In some embodiments, the first cell area 103A includes one or more gate (PO) structures or gates 322, all of which extending long the second direction, spaced from each other, and across the first channel 312 and the second channel 314. In some embodiments, the leftmost gate structure 322L and the rightmost gate structure 322R are dummy gates, and both of them define a first cell pitch P1 of the first cell area 103A along the first direction.

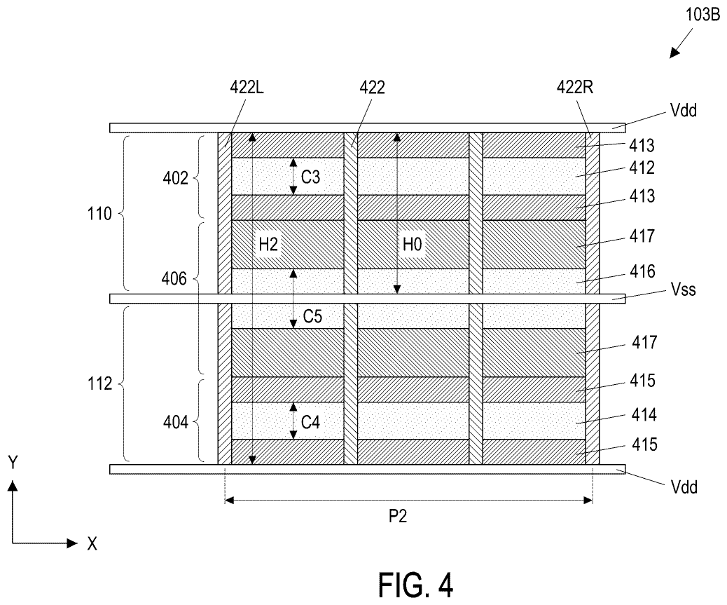

FIG. 4 illustrates a schematic diagram of a second cell area (e.g., 103B) of a plurality of cell areas included in the integrated circuit layout 100 of FIG. 1 in accordance with some embodiments. As shown in FIG. 1, the second cell area 103B is arranged in a space 102 that includes a plurality of uniform cell rows (e.g., 110, 112 and 114). Each uniform cell row (e.g., 110) extends along a first direction (X direction) in the space 102, and has a uniform row height H0 along a second direction (Y direction) perpendicular to the first direction. The second cell area 103B is placed within two corresponding adjacent rows (e.g., 110 and 112) of the plurality of rows (e.g., 110, 112 and 114), and the second cell area 103B has a cell height H2 along the second direction and equal to 2 times of the uniform row height H0, that is H2=2×H0. As shown in FIG. 4, top and bottom boundaries of the second cell area 103B are respectively defined in the second direction by two corresponding power lines.

As shown in FIG. 4, in some embodiments, the second cell area 103B includes a first sub-area 402 including a first channel 412 of a first type of doping and extending across the second cell area 103B along the first direction, the first channel 412 being formed in a first well 413 of a second type of doping, opposite to the first type of doping; a second sub-area 404 including a second channel 414 of the first type of doping and extending across the second cell area 103B along the first direction, the second channel 414 being formed in a second well 415 of the second type of doping; and a third sub-area 406 including a third channel 416 of the second type of doping and extending across the second cell area 103B along the first direction, the third channel 416 being formed in a third well 417 of the first type of doping. The third sub-area 406 is placed abutting and between the first sub-area 402 and the second sub-area 404 along the second direction. In some embodiments, the first type of doping is p-type and the second type of doping is n-type, while in other embodiments, the first type of doping is n-type and the second type of doping is p-type. Thus, the second cell area 103B can be a PNP type or an NPN type.

In some embodiments, the first channel 412 of the second cell area 103B has a first channel width C3 extending along the second direction, the second channel 414 of the second cell area 103B has a second channel width C4 extending along the second direction, and the third channel 416 of the second cell area 103B has a third channel width C5 extending along the second direction. In some embodiments, the first channel width C3 and the second channel width C4 of the second cell area 103B are identical, while in other embodiments the first channel width C3 and the second channel width C4 of the second cell area 103B are different. In some embodiments, the third channel width C5 of the second cell area 103B is greater than any of the first channel width C3 and the second channel width C4 of the second cell area 103B. In some embodiments, the third channel width C5 of the second cell area 103B is less than a sum of the first channel width C3 and the second channel width C4 of the second cell area 103B. In some embodiments, the second cell area 103B includes one or more gate (PO) structures or gates 422, all of which extending long the second direction, spaced from each other, and across the first channel 412, the second channel 414, and the third channel 416. In some embodiments, the leftmost gate structure 422L and the rightmost gate structure 422R are dummy gates, and both of them define a second cell pitch P2 of the second cell area 103B along the first direction.

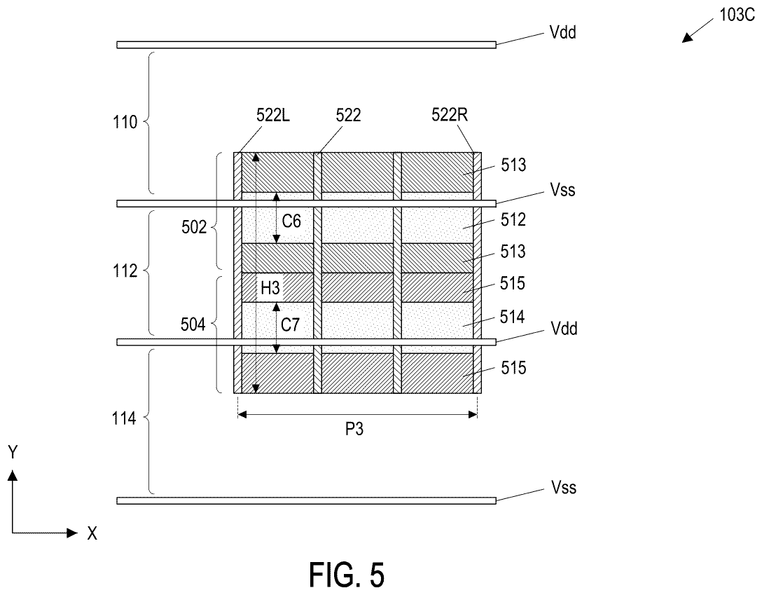

FIG. 5 illustrates a schematic diagram of a third cell area (e.g., 103C) of a plurality of cell areas included in the integrated circuit layout 100 of FIG. 1 in accordance with some embodiments. As shown in FIG. 1, the third cell area 103C is arranged in a space 102 that includes a plurality of uniform cell rows (e.g., 110, 112 and 114). Each uniform cell row (e.g., 110) of the plurality of uniform cell rows extends along a first direction (X direction) in the space 102, and has a uniform row height H0 along a second direction (Y direction) perpendicular to the first direction. As shown in FIG. 5, in contrast to the arrangement of the first cell area 103A, the third cell area 103C is placed partially within or across three corresponding adjacent rows (e.g., 110, 112 and 114) of the plurality of rows along the second direction. For example, the third cell area 103C is placed partially within or across a portion of cell row 110, an entire cell row 112, and a portion of cell row 114 along the second direction.

As shown in FIG. 5, in some embodiments, the third cell area 103C includes a first sub-area 502 of PMOS type, and a second sub-area 504 of NMOS type abutting the first sub-area 502 along the second direction. The first sub-area 502 of the third cell area 103C includes a first channel 512 of p-type that extends across the third cell area 103C along the first direction. The first channel 512 of the third cell area 103C has a first channel width C6 along the second direction, and is formed in a first well 513 of n-type of the third cell area 103C. The second sub-area 504 of the third cell area 103C includes a second channel 514 of n-type that extends across the third cell area 103C along the first direction. The second channel 514 of the third cell area 103C has a second channel width C7 along the second direction, and is formed in a second well 515 of p-type of the third cell area 103C. In some embodiments, the second channel width C7 and the first channel height C6 of the third cell area 103C are identical, while in other embodiments, the second channel width C7 and the first channel height C6 of the third cell area 103C are different. The third cell area 103C includes one or more gate (PO) structures or gates 522, all of which extending long the second direction, separated from each other, and across the first channel 512 and the second channel 514 of the third cell area 103C. In some embodiments, the leftmost gate structure 522L and the rightmost gate structure 522R are dummy gates, and both of them define a third cell pitch P3 of the third cell area 103C along the first direction.

In some embodiments, any of the first channel width C6 and the second channel width C7 of the third cell area 103C is greater than any of the first channel width C1 and the second channel width C2 of the first cell area 103A along the second direction. In some embodiments, a third height H3 of the third cell area 103C is greater than a first height H1 of the first cell area 103A along the second direction. In some embodiments, a third height H3 of the third cell area 103C is greater than a second height H2 of the second cell area 103B along the second direction, while in other embodiments, the third height H3 of the third cell area 103C is less than the second height H2 of the second cell area 103B along the second direction.

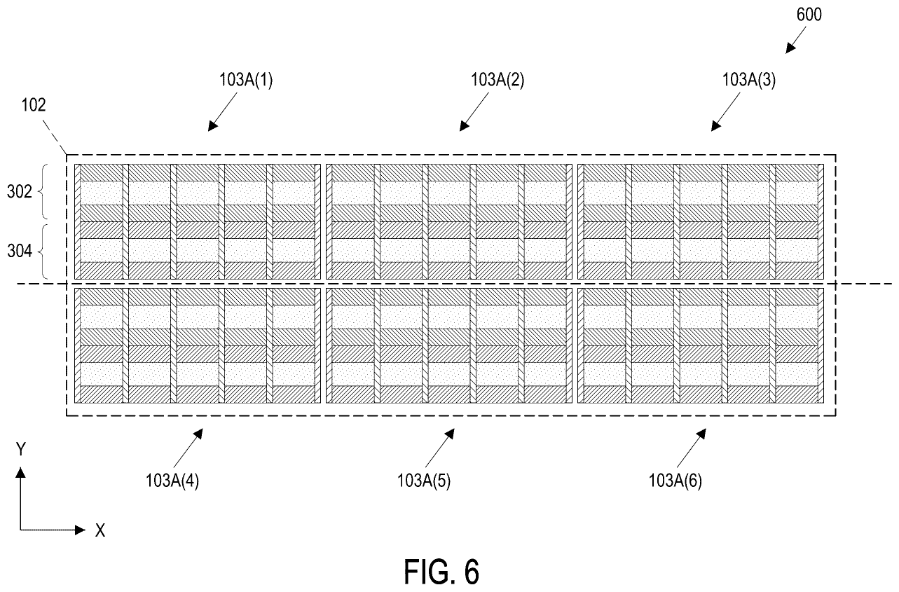

FIG. 6 illustrates an example integrated circuit layout 600 of a plurality of cell areas included in the integrated circuit layout of FIG. 1 in accordance with an embodiments. In some embodiments, the integrated circuit layout 600 includes a space 102 arranged for the integrated circuit layout 600. In some embodiments, the space 102 is configured to create a nano-sheet transistor. In some embodiments, as shown in FIG. 1, the space 102 includes a plurality of rows (e.g., 110, 112 and 114) extending along a first direction (X direction), each of the plurality of rows (e.g., 110) having a uniform row height H0 along a second direction (Y direction) perpendicular to the first direction. The integrated circuit layout 600 also includes a plurality (e.g., six) of first cell areas 103A of PN type, such as 103A(1), 103A(2), 103A(3), 103A(4), 103A(5), and 103A(6), etc., arranged in the space 102, one first cell area of the plurality of first cell areas 103A being placed within one corresponding row (e.g., 112 in FIG. 1) of the plurality of rows (e.g., 110, 112 and 114 in FIG. 1). Even though six first cell areas 103A are shown to be included in the space 102, the number of the first cell areas 103A is not limited to six and can be any integer number.

As shown in FIG. 3, in some embodiments, the first cell area 103A includes a first sub-area 302 including a first channel 312 (e.g., p-type) extending across the first cell area 103A along the first direction, the first channel having a first channel width C1 along the second direction; and a second sub-area 304 directly abutting the first sub-area 302 along the second direction, and including a second channel 314 (e.g., n-type) extending across the first cell area 103A along the first direction, the second channel having a second channel width C2 along the second direction. The height H1 of the first cell area 103A is equal to the uniform row height H0 along the second direction. Also as shown in FIG. 6, in some embodiments, the plurality of first cell areas 103A are arranged abutting each other along the first and the second directions and aligned with each other along the first and the second directions, and each of the plurality of first cell areas 103A includes a first sub-area 302 and a second sub-area 304. For example, a first cell area 103A(1) of the plurality of first cell areas 103A directly abuts another first cell area 103A(2) of the plurality of first cell areas 103A along the first direction, and the first cell area 103 (1) directly abuts still another first cell area 103A(4) of the plurality of first cell areas 103A along the second direction.

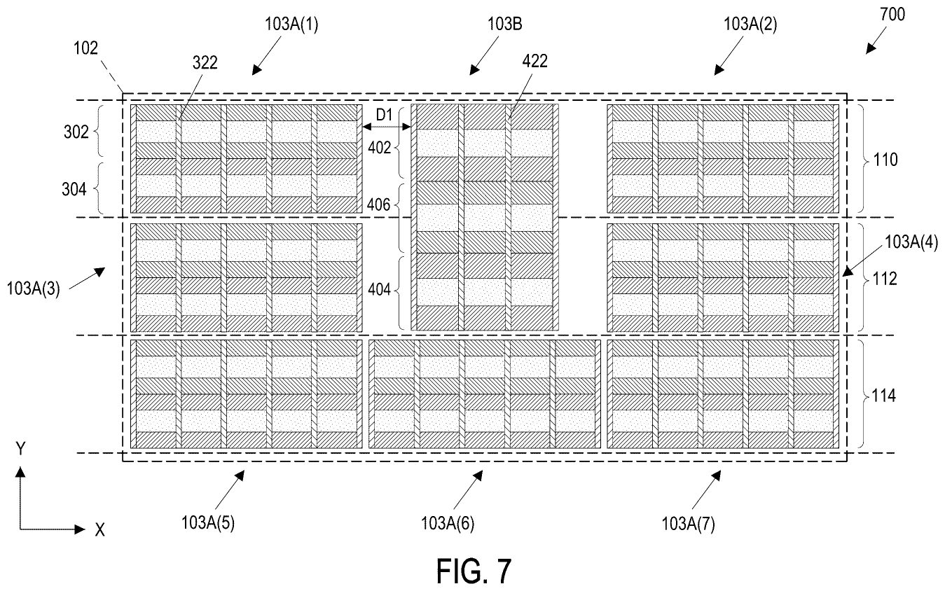

FIG. 7 illustrates another example layout 700 of a plurality of cell areas included in the integrated circuit layout of FIG. 1 in accordance with another embodiments. In some embodiments, the integrated circuit layout 700 includes a space 102 arranged for the integrated circuit layout 700. In some embodiments, the space 102 is configured to create a nano-sheet transistor. In some embodiments, as shown in FIG. 1, the space 102 includes a plurality of rows (e.g., 110, 112 and 114) extending along a first direction (X direction), each of the plurality of rows (e.g., 110) having a uniform row height H0 along a second direction (Y direction) perpendicular to the first direction. The integrated circuit layout 700 also includes one or more first cell areas 103A (e.g., of PN type) each being placed within one corresponding row (e.g., 110) of the plurality of rows, and one or more second cell areas (e.g., of PNP type) each being placed within two corresponding adjacent rows (e.g., 110 and 112) of the plurality of rows.

As shown in FIG. 3, in some embodiments, a first cell area 103A includes a first sub-area 302 including a first channel 312 (e.g., p-type) extending across the first cell area 103A along the first direction, the first channel having a first channel width C1 along the second direction; and a second sub-area 304 directly abutting the first sub-area 302 along the second direction, and including a second channel 314 (e.g., n-type) extending across the first cell area 103A along the first direction, the second channel having a second channel width C2 along the second direction. The height H1 of the first cell area 103A is equal to the uniform row height H0 along the second direction.

As shown in FIG. 4, in some embodiments, the second cell area 103B includes a first sub-area 402 including a first channel 412 of a first type of doping and extending across the second cell area 103B along the first direction, the first channel 412 being formed in a first well 413 of a second type of doping, opposite to the first type of doping; a second sub-area 404 including a second channel 414 of the first type of doping and extending across the second cell area 103B along the first direction, the second channel 414 being formed in a second well 415 of the second type of doping; and a third sub-area 406 including a third channel 416 of the second type of doping and extending across the second cell area 103B along the first direction, the third channel 416 being formed in a third well 417 of the first type of doping. The third sub-area 406 is placed abutting and between the first sub-area 402 and the second sub-area 404 along the second direction.

In some embodiments, as shown in FIG. 7, a first cell area 103A (e.g., 103A(1)) of the first cell areas 103A is laterally separated from a second cell area 103B of the second cell areas along the first direction by a first distance D1, and another first cell area 103A (e.g., 103 (6)) of the first cell areas directly abuts the second cell area 103B along the second direction. The first distance D1 is in a range from a width of a gate structure 422 and five times of the width of the gate structure 422.

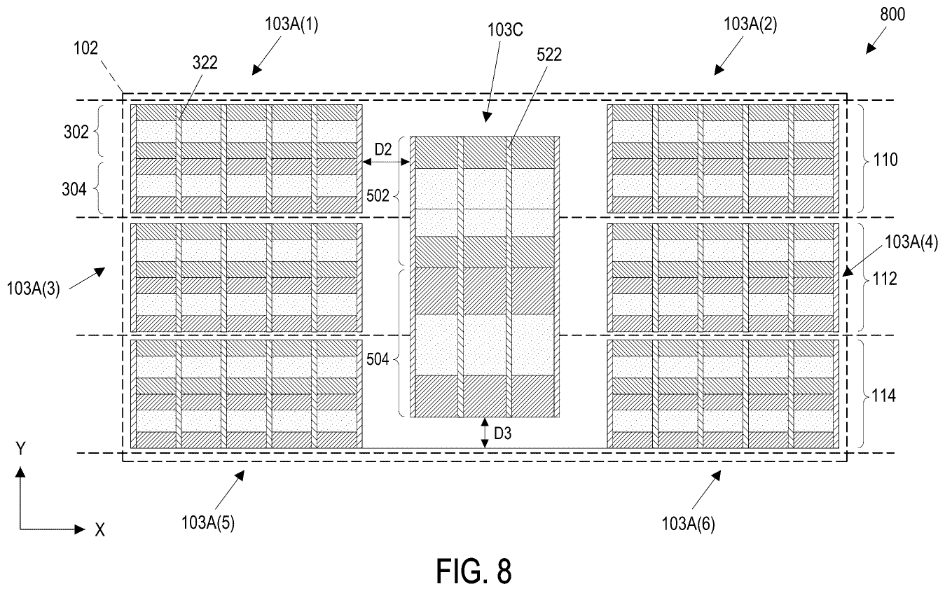

FIG. 8 illustrates a still another example layout 800 of a plurality of cell areas included in the integrated circuit layout of FIG. 1 in accordance with still another embodiments. In some embodiments, the integrated circuit layout 800 includes a space 102 arranged for the integrated circuit layout 800. In some embodiments, the space 102 is configured to create a nano-sheet transistor. In some embodiments, as shown in FIG. 1, the space 102 includes a plurality of rows (e.g., 110, 112 and 114) extending along a first direction (X direction), each of the plurality of rows (e.g., 110) having a uniform row height H0 along a second direction (Y direction) perpendicular to the first direction. The integrated circuit layout 800 also includes one or more first cell areas 103A (e.g., of PN type) each being placed within one corresponding row (e.g., 110) of the plurality of rows, and one or more third cell areas (e.g., of PN type) each being placed partially within or across three corresponding adjacent rows (e.g., 110, 112 and 114) of the plurality of rows.

As shown in FIG. 3, in some embodiments, a first cell area 103A includes a first sub-area 302 including a first channel 312 (e.g., p-type) extending across the first cell area 103A along the first direction, the first channel having a first channel width C1 along the second direction; and a second sub-area 304 directly abutting the first sub-area 302 along the second direction, and including a second channel 314 (e.g., n-type) extending across the first cell area 103A along the first direction, the second channel having a second channel width C2 along the second direction. The height H1 of the first cell area 103A is equal to the uniform row height H0 along the second direction.

As shown in FIG. 5, in some embodiments, a third cell area 103C includes a first sub-area 502 of PMOS type, and a second sub-area 504 of NMOS type abutting the first sub-area 502 along the second direction. The first sub-area 502 of the third cell area 103C includes a first channel 512 of p-type that extends across the third cell area 103C along the first direction. The first channel 512 of the third cell area 103C has a first channel width C6 along the second direction, and is formed in a first well 513 of n-type of the third cell area 103C. The second sub-area 504 of the third cell area 103C includes a second channel 514 of n-type that extends across the third cell area 103C along the first direction. The second channel 514 of the third cell area 103C has a second channel width C7 along the second direction, and is formed in a second well 515 of p-type of the third cell area 103C. The third cell area 103C includes one or more gate (PO) structures or gates 522, all of which extending long the second direction, separated from each other, and across the first channel 512 and the second channel 514 of the third cell area 103C.

As shown in FIG. 8, in some embodiments, a first cell area 103A (e.g., 103A(1)) of the first cell areas 103A is laterally separated from a third cell area 103C of the third cell areas along the first direction (X direction) by a second distance D2. The second distance D2 is in a range from a width of a gate structure 522 and five times of the width of the gate structure 522. In some embodiments, as shown in FIG. 8, a third cell area 103C of the third cell areas is vertically separated from another first cell area 103A (not shown) of the first cell areas 103A along the second direction (Y direction) by a third distance D3. The third distance D3 is in a range from a width of a gate structure 522 and five times of the width of the gate structure 522.

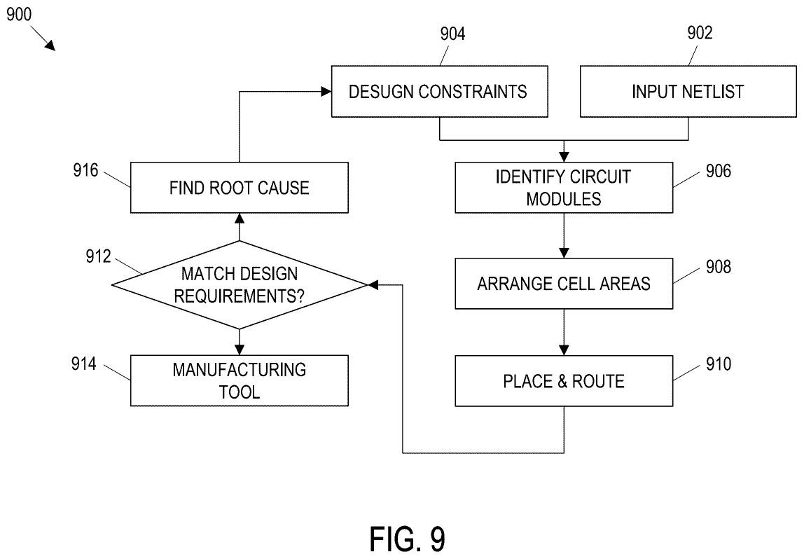

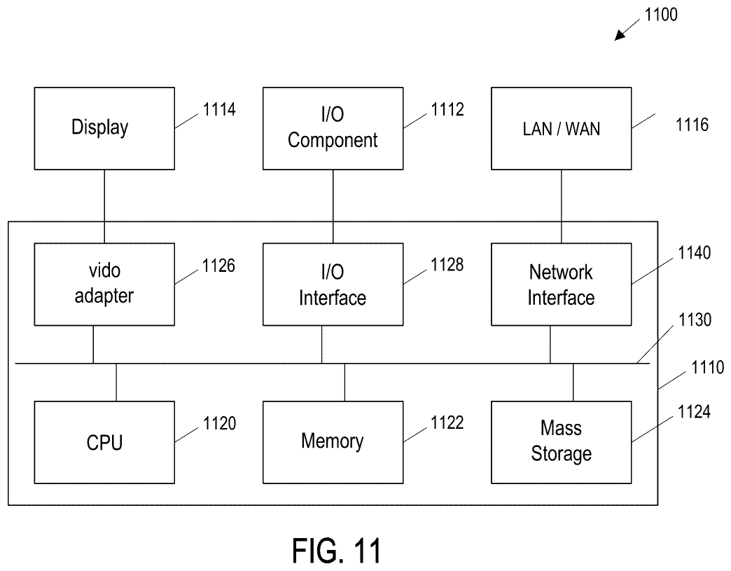

FIG. 9 illustrates a flow chart of an example method 900 of generating an integrated circuit layout including one or more cell areas (such as 103A, 103B, and/or 103C) having different configurations of active regions (ODs) in accordance with some embodiments. In some embodiments, the method 900 may be collectively referred to as an EDA. The operations of the method 900 are performed by the respective components illustrated in FIG. 11. For purposes of discussion, the following embodiment of the method 900 will be described in conjunction with FIG. 11. The illustrated embodiment of the method 900 is merely an example. Therefore, it is understood that any of a variety of operations may be omitted, re-sequenced, and/or added while remaining within the scope of the present disclosure.

The method 900 starts with provision operations of “input netlist 902,” and “design constraints 904,” in accordance with some embodiments. The input netlist 902 may be a functionally equivalent logic gate-level circuit description provided through a synthesis process. The synthesis process forms the functionally equivalent logic gate-level circuit description by matching one or more behavior and/or functions to (standard) cells from a set of cell libraries. The behavior and/or functions are specified based upon various signals or stimuli applied to the inputs of an overall design of the integrated circuit (e.g., the integrated circuit 100), and may be written in a suitable language, such as a hardware description language (HDL). The input netlist 902 may be uploaded into the processing unit 1110 through the I/O interface 1128 (in FIG. 11), such as by a user creating the file while the EDA is executing. Alternately, the input netlist 902 may be uploaded and/or saved on the memory 1122 or mass storage device 1124, or the input netlist 902 may be uploaded through the network interface 1140 from a remote user (in FIG. 11). In these instances, the CPU 1120 shall access or interface with the input netlist 902 during execution of the EDA.

The user also provides the design constraints 904 in order to constrain the overall design of a physical layout of the input netlist 902. In some embodiments, the design constraints 904 may be input, for example, through the I/O interface 1128, downloading through the network interface 1140, or the like (in FIG. 11). The design constraints 904 may specify timing, process parameters, and other suitable constraints with which the input netlist 902, once physically formed into an integrated circuit, must comply.

The method 900 proceeds to operation 906 to “identify circuit modules,” in accordance with some embodiments. Based on the input netlist 902 and/or the design constraints 904, the disclosed system can recognize, identify, or otherwise determine one or more circuit modules that are specified by the user, for example, to be constituted by one or more cell areas (such as 103A, 103B, and/or 103C) having different configurations of active regions (ODs). For example, the system may identify a first circuit module in response to the input netlist 902 specifying that the first circuit module is power-orientated circuit module, which shall consist of first cell areas (e.g., 103A). For example, the system may identify a second circuit module in response to the input netlist 902 specifying that the second circuit module is a performance-orientated circuit module, which shall consist of third cell areas (e.g., 103C).

Alternately or additionally, the system can identify a circuit module, which shall consist of first cell areas (e.g., 103A) or second cell areas (e.g., 103B), or shall consist of first cell areas (e.g., 103A) or third cell areas (e.g., 103C), or shall consist of first cell areas (e.g., 103A), second cell areas (e.g., 103B) or third cell areas (e.g., 103C), by determining at least one of a timing constraint, a performance constraint, or a power constraint corresponding to the circuit module. The system can access, communicate with, or otherwise interface with the design constraints 904 to determine such timing/performance/power constraint(s). In some embodiments, the system can identify, based on the input netlist 902, one or more circuit modules that shall not consist of only the tall or short cells. Continuing with the above example, the system may identify a third circuit module in response to the input netlist 902 specifying that the third circuit module has a more flexible profile.

The method 900 proceeds to operation 908 to “arrange cell areas” in accordance with some embodiments. In response to identifying one or more circuit modules that shall consist of either the first, the second, or the third cell areas (e.g., in the operation 906), the system can arrange corresponding cell areas (such as 103A, 103B and/or 103C) having different configurations of active regions (ODs). Features of cell areas (such as 103A, 103B and/or 103C) have been described with respect to FIGS. 3-5 respectively.

The method 900 proceeds to operation 910 to “place and route,” in accordance with some embodiments. In response to arranging the corresponding cell areas (such as 103A, 103B and/or 103C) having different configurations of active regions (ODs) for respective circuit modules, the system can place and route cells to generate an actual physical design for the overall integrated circuit. The operation 910 is configured to form the physical design by taking the chosen cells from cell libraries and placing them into respective cell rows. The placement of each cell within the cell rows, and the placement of each cell row in relation to other cell rows, may be guided by cost functions in order to minimize wiring lengths and cell area requirements of the resulting integrated circuit. This placement may be done either automatically through the operation 910, or else may alternately be performed partly through a manual process, whereby the user may manually insert one or more cells into a cell row.

The method 900 then proceeds to operation 912 to determine whether the actual physical design for the overall integrated circuit “match design requirements,” in accordance with some embodiments. In response to generating the actual physical design for the overall integrated circuit (in the operation 910), the system can check, monitor, or otherwise determine whether the design requirements are matched. Various requirements may be checked such as, for example, a timing quality of the actual physical design for the overall integrated circuit, a power quality of the actual physical design for the overall integrated circuit, whether a local congestion issue exists, etc., by performing one or more simulations using circuit simulators, e.g., Simulation Program with Integrated Circuit Emphasis (SPICE).

If all the design requirements are met, the method 900 continues to operation 914 of “manufacturing tool.” On the other hand, if not all of the design requirements are met, the method 900 continues to operation 916 of “find root causes.”

The system can perform the operation 916 to find the causes resulting in the failure of meeting the design requirements in the determination operation 912. Various causes may result in the failure. Based on which of the causes is or are, the method 900 may proceed to a respective operation to re-perform that operation. For example, when the cause is due to an incorrect arrangement of cell row(s), the method 900 may proceed to an operation (e.g., the operation 904) to re-assess the constraints specified therein. When the cause is due to an infeasibility of synthesizing the functionally equivalent logic gate-level circuit description, the method 900 may proceed to an operation (e.g., the operation 904) to re-assess the constraints specified therein. When cause is due to an infeasibility of generating the actual physical design, the method 900 may proceed to an operation (e.g., the operation 910) to re-place and/or re-route.

The system can perform the manufacturing tool 914 to generate, e.g., photolithographic masks, which may be used in physically manufacturing the physical design. The physical design may be sent to the manufacturing tool 914 through the LAN/WAN 1116.

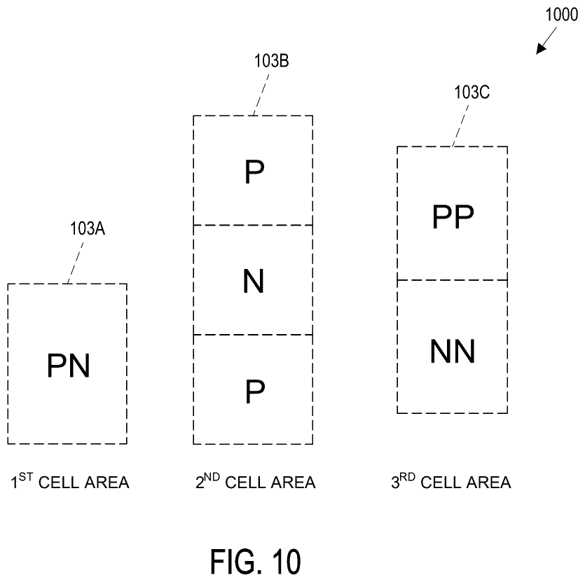

FIG. 10 illustrates a schematic diagram of a portion of a netlist in accordance with some embodiments. As shown in FIG. 10, a portion of a netlist (during synthesis) 1000, which can be one of the above-described windows, includes e.g., “a first cell area” 103A, “a second cell area” 103B, and “a third cell area” 103C as shown in FIGS. 1 and 3-5 respectively.

Referring to FIGS. 1 and 3, the first cell area 103A (e.g., of PN type) is arranged in a space 102 that includes a plurality of uniform cell rows (e.g., 110, 112 and 114), is placed within a corresponding uniform row (e.g., 112) of the plurality of uniform rows, and has a cell height H1 along the second direction and equal to the uniform row height H0. The first cell area 103A includes a first sub-area 302 of PMOS type, and a second sub-area 304 of NMOS type abutting the first sub-area 302 along the second direction. The first sub-area 302 includes a first channel 312 of p-type that extends across the first cell area 103A along the first direction. The first channel 312 has a first channel width C1 along the second direction, and the first channel 312 is formed in a first well 313 of n-type. The second sub-area 304 includes a second channel 314 of n-type that extends across the first cell area 103A along the first direction. The second channel 314 has a second channel width C2 along the second direction, and the second channel 314 is formed in a second well 315 of p-type.

Referring to FIGS. 1 and 4, the second cell area 103B (e.g., of PNP type) is arranged in a space 102 that includes a plurality of uniform cell rows (e.g., 110, 112 and 114), is placed within two corresponding adjacent rows (e.g., 110 and 112) of the plurality of rows, and has a cell height H2 along the second direction and equal to 2 times of the uniform row height H0, that is H2=2×H0. The second cell area 103B includes a first sub-area 402 including a first channel 412 of a first type of doping and extending across the second cell area 103B along the first direction, the first channel 412 being formed in a first well 413 of a second type of doping, opposite to the first type of doping; a second sub-area 404 including a second channel 414 of the first type of doping and extending across the second cell area 103B along the first direction, the second channel 414 being formed in a second well 415 of the second type of doping; and a third sub-area 406 including a third channel 416 of the second type of doping and extending across the second cell area 103B along the first direction, the third channel 416 being formed in a third well 417 of the first type of doping. The third sub-area 406 is placed abutting and between the first sub-area 402 and the second sub-area 404 along the second direction. In some embodiments, the first channel 412 of the second cell area 103B has a first channel width C3 extending along the second direction, the second channel 414 of the second cell area 103B has a second channel width C4 extending along the second direction, and the third channel 416 of the second cell area 103B has a third channel width C5 extending along the second direction.

Referring to FIGS. 1 and 5, the third cell area 103C (e.g., of PPNN type) is arranged in a space 102 that includes a plurality of uniform cell rows (e.g., 110, 112 and 114), is placed partially within or across three corresponding adjacent rows (e.g., 110, 112 and 114) of the plurality of rows, and includes a first sub-area 502 of PMOS type, and a second sub-area 504 of NMOS type abutting the first sub-area 502 along the second direction. The first sub-area 502 of the third cell area 103C includes a first channel 512 of p-type that extends across the third cell area 103C along the first direction. The first channel 512 of the third cell area 103C has a first channel width C6 along the second direction, and is formed in a first well 513 of n-type of the third cell area 103C. The second sub-area 504 of the third cell area 103C includes a second channel 514 of n-type that extends across the third cell area 103C along the first direction. The second channel 514 of the third cell area 103C has a second channel width C7 along the second direction, and is formed in a second well 515 of p-type of the third cell area 103C. In some embodiments, any of the first channel width C6 and the second channel width C7 of the third cell area 103C is greater than any of the first channel width C1 and the second channel width C2 of the first cell area 103A along the second direction.

FIG. 11 illustrates a block diagram of an example information handling system (HIS) in accordance with some embodiments of the present invention. The IHS 1100 may be a computer platform used to implement any or all of the processes discussed herein to design an integrated circuit. The HIS 1100 may comprise a processing unit 1110, such as a desktop computer, a workstation, a laptop computer, or a dedicated unit customized for a particular application. The HIS 1100 may be equipped with a display 1114 and one or more input/output (I/O) components 1112, such as a mouse, a keyboard, or printer. The processing unit 1110 may include a central processing unit (CPU) 1120, memory 1122, a mass storage device 1124, a video adapter 1126, and an I/O interface 1128 connected to a bus 1130.

The bus 1130 may be one or more of any type of several bus architectures including a memory bus or memory controller, a peripheral bus, or video bus. The CPU 1120 may comprise any type of electronic data processor, and the memory 1122 may comprise any type of system memory, such as static random access memory (SRAM), dynamic random access memory (DRAM), or read-only memory (ROM).

The mass storage device 1124 may comprise any type of storage device configured to store data, programs, and other information and to make the data, programs, and other information accessible via the bus 1130. The mass storage device 1124 may comprise, for example, one or more of a hard disk drive, a magnetic disk drive, an optical disk drive, or the like.

The video adapter 1126 and the I/O interface 1128 provide interfaces to couple external input and output devices to the processing unit 1110. As illustrated in FIG. 11, examples of input and output devices include the display 1114 coupled to the video adapter 1126 and the I/O components 1112, such as a mouse, keyboard, printer, and the like, coupled to the I/O interface 1128. Other devices may be coupled to the processing unit 1110, and additional or fewer interface cards may be utilized. For example, a serial interface card (not shown) may be used to provide a serial interface for a printer. The processing unit 1110 also may include a network interface 1140 that may be a wired link to a local area network (LAN) or a wide area network (WAN) 1116 and/or a wireless link.

It should be noted that the HIS 1100 may include other components/devices. For example, the HIS 1100 may include power supplies, cables, a motherboard, removable storage media, cases, and the like. These other components/devices, although not shown, are considered part of the HIS 1100.

In some embodiments of the present invention, an Electronic Design Automation (EDA) is program code that is executed by the CPU 1120 to analyze a user file to obtain the layout of an integrated circuit (e.g., the integrated circuit layout 1100 discussed above). Further, during the execution of the EDA, the EDA may analyze functional components of the layout, as is known in the art. The program code may be accessed by the CPU 1120 via the bus 1130 from the memory 1122, mass storage device 1124, or the like, or remotely through the network interface 1140.

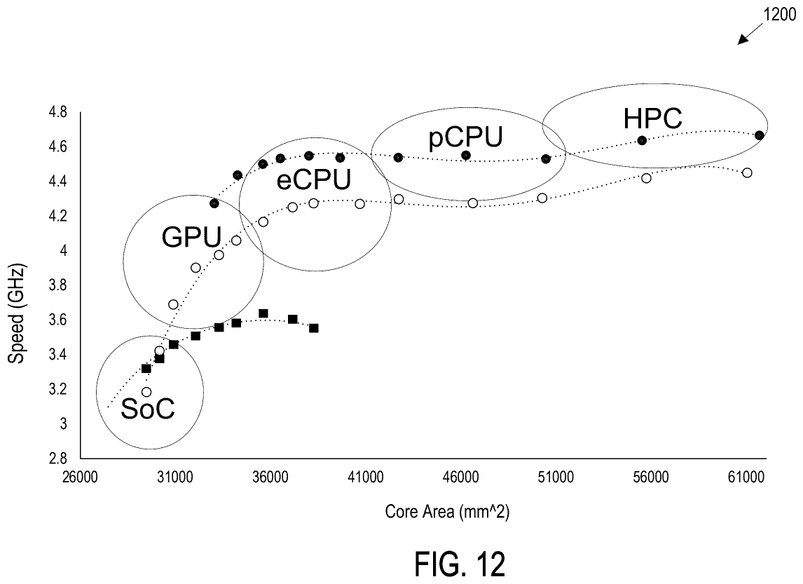

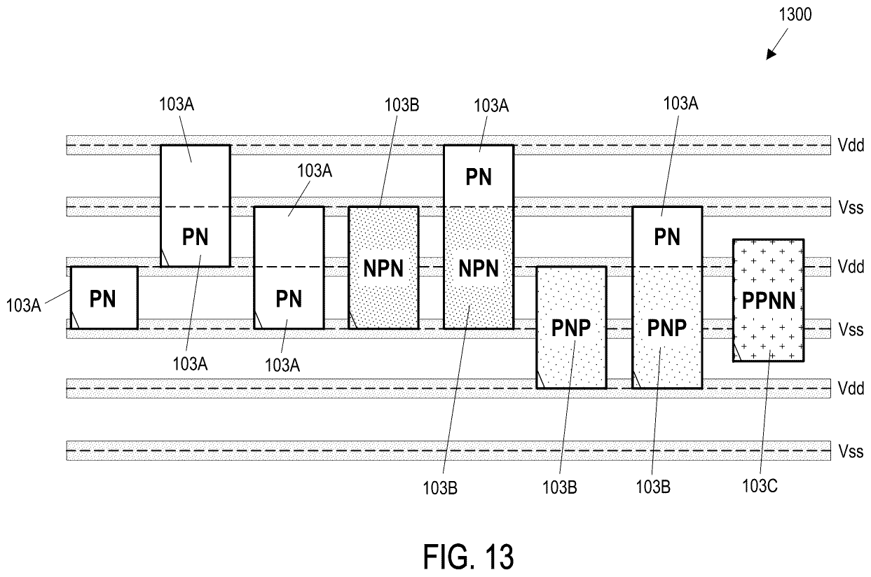

FIG. 12 is a chart 1200 illustrating different trends or requirements for different integrated circuit applications. As shown in FIG. 12, different integrated circuit applications (such as SoC, GPU, eCPU, pCPU, and HPC etc.) have different trends or requirements on core areas and speeds. FIG. 13 illustrates a further layout 1300 of a plurality of cell areas included in an integrated circuit layout of FIG. 1 in accordance with still another embodiments. As shown in FIG. 13, different combinations of a plurality of cell areas (such as the first cell areas 103A, the second cell areas 103B, and the third cell areas 103C) with different OD heights can be used according to, among other things, different trends or requirements of the integrated circuit applications on core areas and speeds. Various advantages may be presented by the integrated circuit layout 1300 adopting the configuration of merged ODs in the present application. The configuration of merged ODs may bring optimized and/or balanced power, performance, and area considerations throughout the design processes for various IC applications, thereby leading to overall improved performance, power efficiency, and area efficiency.

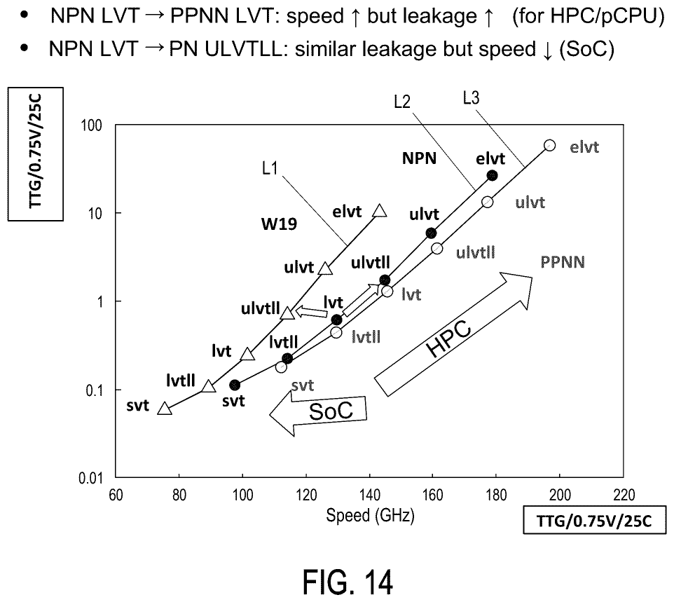

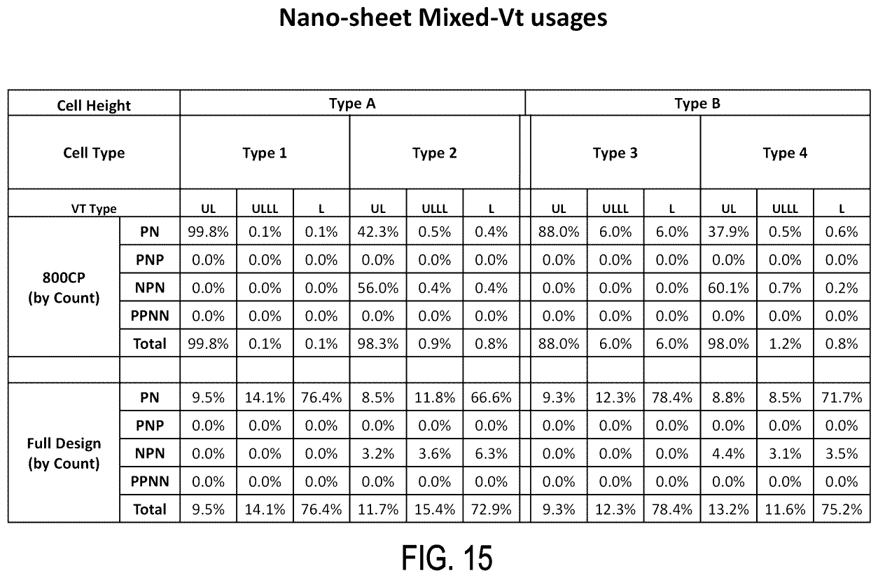

FIG. 14 is a chart illustrating different trends or performances for different technical approaches by using, for example, mixed (or adjusted) threshold voltage (Vt) devices, merged-OD devices, and adjusted OD size devices. In FIG. 14, line L1 represents a PN merged-OD design (103A in FIG. 13), line L2 represents a NPN merged-OD design (103B in FIG. 13), line L3 represents a PPNN merged-OD designed (103C in FIG. 13). W19 represents OD size (19 nm). SVT (Standard Threshold Voltage), LVTLL (Low Threshold Voltage with Low Leakage), LVT (Low Threshold Voltage), ULVTLL (Ultra-Low Threshold Voltage with Low Leakage), ULVT (Ultra-Low Threshold Voltage), and ELVT (Extra-Low Threshold Voltage) represent different threshold voltage (VT) types. TTG/0.75V/25C represents a PVT (Process, Voltage, Temperature) corner. With reference to FIG. 14, for a digital design, different technical approaches, e.g., as mentioned above, can be adopted to optimize power and speed performance to meet different requirements from different applications. For example, a SoC needs relatively low power and speed, a HPC needs relatively high speed but has no power concern, and thus their optimized trends are different. Different VT types (e.g., LVTLL) adopted by semiconductor devices impact performances (such as leakage and speed) thereof. FIG. 15 is a table that illustrates nano-sheet mixed threshold voltage (Vt) usages. Nanosheet transistors allow for better control of the channel by the gate, reducing leakage and improving performance. In FIG. 15, there are two cell height designs, one cell height design is called “Type A”, and another cell height design is “Type B”. Critical paths 800CP are inside paths for speed constraints and power distributions. In the table as shown in FIG. 15, a label “UL” represents a type of Ultra-Low Threshold Voltage (ULVT) transistors, a label “ULLL” represents a type of Ultra-Low Threshold Voltage with Low Leakage (ULVTLL) transistors, and a label “L” represents a type of Low Threshold Voltage (LVT) transistors.

With reference to FIGS. 14 and 15, in semiconductor design, different mixed threshold voltages (Vt) are used to optimize performance and power consumption. A mixed Vt approach allows for optimizing the trade-off between performance and power efficiency by using different threshold voltages for different parts of the circuit. Nanosheet transistors can be designed to support multiple threshold voltage options to cater to diverse application requirements. For example, SVT transistors can provide a balance between speed and power consumption. ULVT transistors have a very low threshold voltage and switch on at lower voltages, and are typically used in critical performance paths where speed is paramount. ULVTLL transistors are designed to have ultra-low threshold voltages with additional techniques to minimize leakage, and can provide high performance similar to ULVT transistors while incorporating design optimizations to reduce leakage, balancing speed and power efficiency better. LVT transistors have a low threshold voltage, and can offer a compromise between the high-speed operation of ULVT transistors and the lower leakage of SVT transistors. Thus, different VT types used allows for good control over the speed and power performances of semiconductor devices, enabling designers to optimize their circuits for a wide range of applications and requirements.

In one aspect of the present disclosure, an integrated circuit layout is provided. The integrated circuit layout includes a cell area including a plurality of cell rows extending along a first direction, each of the plurality of cell rows having a uniform row height along a second direction perpendicular to the first direction. The cell area consists of a first area including a plurality of first channels of p-type extending across the cell area along the first direction and separated from each other along the second direction, each of the plurality of first channels having a first channel height along the second direction; and a second area directly abutting the first area along the second direction, and including a plurality of second channels of n-type extending across the cell area along the first direction and separated from each other along the second direction. Each of the plurality of second channels having a second channel height different from the first channel height along the second direction.

In another aspect of the present disclosure, an integrated circuit layout is provided. The integrated circuit layout includes a space arranged for an integrated circuit layout, and a cell area arranged in the space. The cell area includes a plurality of cell rows extending along a first direction and each having a uniform row height along a second direction perpendicular to the first direction. The cell area consists of a first area including a plurality of first channels completely extending across the cell area along the first direction and separated from each other along the second direction, each of the plurality of first channels having a first channel height along the second direction; and a second area directly abutting the first area along the second direction, and including a plurality of second channels partially extending across the cell area along the first direction and separated from each other along the second direction. Each of the plurality of second channels has a second channel height different from the first channel height along the second direction.

In yet another aspect of the present disclosure, an integrated circuit layout is provided. The integrated circuit layout includes a space arranged for the integrated circuit layout; a first cell area arranged in the space and including a first plurality of cell rows extending along a first direction and each having a uniform row height along a second direction perpendicular to the first direction; and a second cell area arranged in the space and including a second plurality of cell rows extending along the first direction and each having the uniform row height along the second direction. The first cell area consists of a first area including a plurality of first channels of p-type extending along the first direction and separated from each other along the second direction, each of the plurality of first channels having a first channel height along the second direction; and a second area directly abutting the first area along the second direction, and including a plurality of second channels of n-type extending along the first direction and separated from each other along the second direction, each of the plurality of second channels having a second channel height greater than the first channel height along the second direction.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit layout, comprising:
a space arranged for the integrated circuit layout and comprising a plurality of rows extending along a first direction, each of the plurality of rows having a uniform row height along a second direction perpendicular to the first direction;
one or more first cell areas arranged in the space, a first cell area of the first cell areas being placed within one corresponding row of the plurality of rows;
one or more second cell areas arranged in the space, a second cell area of the second cell areas being placed within two corresponding adjacent rows of the plurality of rows; and
one or more third cell areas arranged in the space, a third cell area of the third cell areas being placed partially across three corresponding adjacent rows of the plurality of rows.

2. The integrated circuit layout of claim 1, wherein each of the plurality of rows is defined by a first power line of Vdd and a second power line of Vss, both extending along the first direction and adjacent to each other along the second direction.

3. The integrated circuit layout of claim 1, wherein the first cell area comprises:
a first sub-area comprising a first channel of a first doping type extending across the first cell area along the first direction, the first channel having a first channel width along the second direction; and
a second sub-area directly abutting the first sub-area along the second direction, and comprising a second channel of a second doping type opposite to the first doping type extending across the first cell area along the first direction, the second channel having a second channel width equal to the first channel width along the second direction.

4. The integrated circuit layout of claim 1, wherein the second cell area comprises:
a third sub-area comprising a third channel of the first doping type, the third channel extending across the second cell area along the first direction and having a third channel width along the second direction;
a fourth sub-area comprising a fourth channel of the first doping type, the fourth channel extending across the second cell area along the first direction and having a fourth channel width equal to the third channel width along the second direction; and
a fifth sub-area placed between the third sub-area and the fourth sub-area along the second direction, and comprising a fifth channel of the second doping type, the fifth channel extending across the second cell area along the first direction and having a fifth channel width greater than any of the third channel width and the fourth channel width along the second direction,
wherein the fifth channel width of the second cell area is greater than the first channel of the first cell area width along the second direction.

5. The integrated circuit layout of claim 1, wherein the third cell area comprises:
a six sub-area comprising a sixth channel of the first doping type, extending across the third cell area along the first direction, and having a sixth channel width along the second direction; and
a seventh sub-area comprising a seventh channel of the second doping type, also extending across the third cell area along the first direction, and having a seventh channel width equal to the sixth channel width along the second direction,
wherein the sixth channel width of the third cell area is greater than the first channel width of the first cell area along the second direction.

6. The integrated circuit layout of claim 5, wherein the third cell area is placed entirely across a first corresponding row of the three corresponding adjacent rows and partially across a second and a third corresponding rows of the three corresponding adjacent rows on opposite sides of the first corresponding row along the second direction.

7. The integrated circuit layout of claim 1, wherein the first cell area of the first cell areas directly abuts and is aligned with another first cell area of the first cell areas along the first direction.

8. The integrated circuit layout of claim 1, wherein the first cell area of the first cell areas directly abuts and is aligned with another first cell area of the first cell areas along the second direction.

9. The integrated circuit layout of claim 1, wherein the second cell area is spaced from any of the first cell area and the third cell area along the first direction.

10. The integrated circuit layout of claim 1, wherein the third cell area is spaced from any of the first cell area and the second cell area along the first direction.

11. The integrated circuit layout of claim 1, wherein the integrated circuit layout is arranged for a nano-sheet transistor, and wherein the nano-sheet transistor comprises:
a plurality of nanosheets stacked on each other,
a gate structure wrapping around each of the plurality of nanosheets,
a first source/drain feature at a first side of the gate structure, and
a second source/drain feature at a second side of the gate structure.

12. An integrated circuit layout, comprising:
a space arranged for the integrated circuit layout and comprising a plurality of rows extending along a first direction, each of the plurality of rows having a uniform row height along a second direction perpendicular to the first direction; and
one or more first cell areas arranged in the space, a first cell area of the first cell areas being placed partially across three corresponding adjacent rows of the plurality of rows, wherein the first cell area comprises:
a first sub-area comprising a first channel of a first doping type, extending across the first cell area along the first direction, and having a first channel width along the second direction; and
a second sub-area comprising a second channel of a second doping type opposite to the first doping type, also extending across the first cell area along the first direction, and having a second channel width equal to the first channel width along the second direction.

13. The integrated circuit layout of claim 12, further comprising:
one or more second cell areas arranged in the space, a second cell area of the second cell areas being placed within one corresponding row of the plurality of rows; and
one or more third cell areas arranged in the space, a third cell area of the third cell areas being placed within two corresponding adjacent rows of the plurality of rows.

14. The integrated circuit layout of claim 13, wherein the second cell area (PN areas) comprises:
a third sub-area comprising a third channel of the first doping type extending across the second cell area along the first direction, the third channel having a third channel width along the second direction; and
a fourth sub-area directly abutting the third sub-area along the second direction, and comprising a fourth channel of the second doping type extending across the second cell area along the first direction, the fourth channel having a fourth channel width equal to the third channel width along the second direction.

15. The integrated circuit layout of claim 13, wherein the first channel width of the first cell area is greater than the second channel width of the second cell area along the second direction.

16. The integrated circuit layout of claim 13, wherein the first cell area is spaced from any of the second cell area and the third cell area along the first direction.

17. A method of generating an integrated circuit layout, comprising:
receiving a design of an integrated circuit;
identifying, from the design of the integrated circuit, a first circuit module of the integrated circuit based on either a user specification or a first common characteristic; and
arranging, based on the identified first circuit module circuit module, at least one first cell area relative to a space that is arranged for the design of the integrated circuit and comprises a plurality of rows extending along a first direction, each of the plurality of rows having a uniform row height along a second direction perpendicular to the first direction, the at least one first being placed partially across three corresponding adjacent rows of the plurality of rows, wherein the at least one first cell area consists of:
a first sub-area comprising a first channel of a first doping type, extending across the first cell area along the first direction, and having a first channel width along the second direction; and
a second sub-area comprising a second channel of a second doping type opposite to the first doping type, also extending across the first cell area along the first direction, and having a first channel width along the second direction.

18. The method of claim 17, further comprising:
placing, into the at least one first cell area, at least one first cell.

19. The method of claim 18, further comprising:
identifying, from the design of the integrated circuit, a second circuit module of the integrated circuit based on either the user specification or a second common characteristic;
arranging, based on the identified second circuit module circuit module, at least one second cell area relative to the space, wherein the at least one second cell area consists of:
a third sub-area comprising a third channel of the first doping type extending across the second cell area along the first direction, the third channel having a second channel width along the second direction; and
a fourth sub-area directly abutting the third sub-area along the second direction, and comprising a fourth channel of the second doping type extending across the second cell area along the first direction, the fourth channel having the second channel width along the second direction,
wherein the first channel width of the first cell area is greater than the second channel width of the second cell area along the second direction.

20. The method of claim 19, further comprising:
placing, into the at least one second cell area, at least one second cell,
wherein the at least one second cell area is spaced from the at least one first cell area along the first direction.
